(19) United States
(12) Patent Application Publication
(10) Pub. No.: US 2025/0012888 A1
(43) Pub. Date: Jan. 9, 2025

(54) GROUPING OF ANTENNAS FOR POSITIONING OF A USER EQUIPMENT

(71) Applicant: QUALCOMM Incorporated, San Diego, CA (US)

(72) Inventors: Varun Amar REDDY, San Diego, CA (US); Alexandros MANOLAKOS, Athens, Attikí (GR); Weimin DUAN, San Diego, CA (US); Danlu ZHANG, San Diego, CA (US)

(21) Appl. No.: 18/705,391

(22) PCT Filed: Nov. 23, 2022
(86) PCT No.: PCT/US2022/080422

§ 371 Date: Apr. 26, 2024

(30) Foreign Application Priority Data
Jan. 27, 2022 (GR) 20220100075

(51) Int. Cl. G01S 5/02

(52) U.S. Cl. CPC G01S 5/0205

(57) ABSTRACT

Various methods and apparatus for supporting positioning of a user equipment (UE) in a wireless network are disclosed. In some embodiments, a wireless network node may be configured to define one or more groups of antennas associated with a wireless network node, each of the one or more groups of antennas grouped according to at least a phase-based parameter correlated with an electromagnetic characteristic of a plurality of antennas; send, to a network entity, data identifying the defined one or more groups of antennas; receive configuration data from the network entity, the configuration data identifying at least one of the one or more groups of antennas; and based on the configuration data, send or receive reference signals with the wireless network node using the identified at least one of the one or more groups of antennas, the reference signals configured to be used in the positioning of the UE.

### BACKGROUND

### 1. Field of Disclosure

The present disclosure relates generally to the field of wireless communications, and more specifically to determining the location of a user equipment (UE) using radio frequency (RF) signals.

### 2. Description of Related Art

The location of a UE, such as a mobile device, may be useful for a number of applications including navigation, direction finding, asset tracking, emergency calls, and Internet service. The location of a UE may be estimated based on information gathered from various systems, such as wireless networks. For instance, in a cellular network implemented according to 4G (also referred to as Fourth Generation) Long Term Evolution (LTE) radio access or 5G (also referred to as Fifth Generation) New Radio (NR), a UE may transmit and/or receive reference signals to and/or from one or more wireless nodes of the cellular network, such as base stations and/or other UEs. An angle of departure (AoD) or an angle of arrival (AoA) of the reference signals may be measured to measure a direction of the UE with respect to the base station.

### BRIEF SUMMARY

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

In one aspect of the present disclosure, a method for supporting positioning of a user equipment (UE) in a wireless network is disclosed. In some embodiments, the method includes: defining one or more groups of antennas associated with a wireless network node; sending, to a network entity of the wireless network, data identifying the defined one or more groups of antennas; receiving configuration data from the network entity, the configuration data identifying at least one group of antennas of the one or more groups of antennas; and based on the configuration data, sending or receiving reference signals with the wireless network node using the identified at least one group of antennas of the one or more groups of antennas, the reference signals configured to be used in the positioning of the UE.

In another aspect of the present disclosure, a wireless network node is disclosed. In some embodiments, the wireless network node includes one or more processors communicatively coupled to at least one wireless communication interface and memory, and configured to: define one or more groups of antennas associated with the wireless network node; send, to a network entity of a wireless network, data identifying the defined one or more groups of antennas; receive configuration data from the network entity, the configuration data identifying at least one group of antennas of the one or more groups of antennas; and based on the configuration data, send or receive reference signals with the wireless network node using the identified at least one group of antennas of the one or more groups of antennas, the reference signals configured to be used in positioning of a user equipment (UE).

In another aspect of the present disclosure, a computerized apparatus is disclosed. In some embodiments, the computerized apparatus includes: means for defining one or more groups of antennas associated with the computerized apparatus; means for sending, to a network entity of a wireless network, data identifying the defined one or more groups of antennas; means for receiving configuration data from the network entity, the configuration data identifying at least one group of antennas of the one or more groups of antennas; and means for, based on the configuration data, sending or receiving reference signals with the computerized apparatus using the identified at least one group of antennas of the one or more groups of antennas, the reference signals configured to be used in positioning of a user equipment (UE).

In another aspect of the present disclosure, a computer-readable apparatus is disclosed. In some embodiments, the computer-readable apparatus includes a storage medium, the storage medium including a plurality of instructions configured to, when executed by one or more processors: define one or more groups of antennas associated with a computerized apparatus; send, to a network entity of a wireless network, data identifying the defined one or more groups of antennas; receive configuration data from the network entity, the configuration data identifying at least one group of antennas of the one or more groups of antennas; and based on the configuration data, send or receive reference signals with the computerized apparatus using the identified at least one group of antennas of the one or more groups of antennas, the reference signals configured to be used in positioning of a user equipment (UE).

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a diagram illustrating an example of beamforming that can be used by difference devices, according to some embodiments.

FIG. 4 illustrates a diagram of an exemplary embodiment of a positioning system (a portion of, e.g., the positioning system of FIG. 1) in which Angle of Departure (AoD)-based positioning and/or Angle of Arrival (AoA)-based positioning may be performed.

FIG. 5 illustrates a diagram of an exemplary wireless communications system implementing user equipment (UE) positioning using an AoA technique.

FIG. 6 illustrates a diagram of an example of how the AoD may be determined based on a phase difference between signals transmitted by antennas.

FIG. 7 illustrates a diagram of a call flow for a positioning procedure using a wireless network such as that shown in FIGS. 1 and 2, according to some embodiments.

FIG. 8 illustrates a diagram of another call flow for a positioning procedure using a wireless network such as that shown in FIGS. 1 and 2, according to some embodiments.

FIG. 9 is a flow diagram of a method for supporting positioning of a UE in a wireless network, according to some embodiments.

FIG. 10 is a block diagram of an embodiment of a UE, which can be utilized in embodiments as described herein.

FIG. 11 is a block diagram of an embodiment of a base station, which can be utilized in embodiments as described herein.

FIG. 12 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals” (PRS), “sounding reference signal” (SRS), “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

These reference signals may be useful to perform positioning. For instance, a UE may transmit an SRS that is received by a wireless network node such as a base station (or another UE). In some cases, the UE may measure an AoD based on the SRS to identify a direction of the UE from the base station. In some cases, the base station may measure an AoA based on the SRS to identify the direction. Similarly, a wireless network node (e.g., a base station) may transmit a PRS to a UE. In some cases, the base station may then measure an AoD based on the PRS to identify a position of the UE with reference to the base station. In some cases, the UE may measure an AoA based on the PRS to identify the position. In some embodiments, a zenith of arrival (ZoA) of the positioning signal may also be measured to identify an elevation of the UE with reference to the base station. A time of arrival (ToA) or time difference of arrival (TDOA) of the positioning signal may also be used to identify a distance of the UE from the base station.

However, these measurements of SRS or PRS may be affected by noise or other types of interference affecting antennas in the UE or the base station, which may impact the accuracy of positioning. More specifically, phase noise can be a significant impairment to phase measurement, which impacts positioning measurements and data communications. Phase noise may occur because of reasons such as variations in RF signal sources and the quality of RF crystals (e.g., quartz crystals) used by wireless devices. Depending on the deployment and device implementation, different subarrays or sub-panels of antennas or antenna elements may use different RF signal sources and therefore have slightly different phase noises. There may also be inconsistencies or imperfections in the crystals manufactured, which may result in the crystals resonating at slightly different frequencies or phases. With multiple antennas, deviations even within acceptable phases may compound.

Phases associated with positioning signals can be particularly significant. A base station or a UE may perform positioning based on phase measurements. The positioning may be sensitive to inconsistent phases. For example, AoD measurements may utilize the phase difference between signals transmitted from different physical antenna, along with, e.g., the distance between the physical antennas. It therefore can be important and beneficial for wireless receivers or transmitters to have information on which antennas have correlated phase noise, thereby allowing improved reliability and precision in determining relative phase and ultimately positioning measurements.

To that end, the present disclosure describes UE positioning techniques that account for the phase noise. In various embodiments disclosed herein, a transmitter (e.g., UE or base station (e.g., gNodeB)) may use specific groups of antennas and/or inform another network entity or be informed by another network entity which antennas to use. The relative phases of the selected groups of antennas may be prone to less error despite the presence of phase noise in that RF source. More directly, antennas may be grouped based on common characteristics such as phase noise to enhance said UE positioning. Additional details will follow after an initial description of relevant systems and technologies.

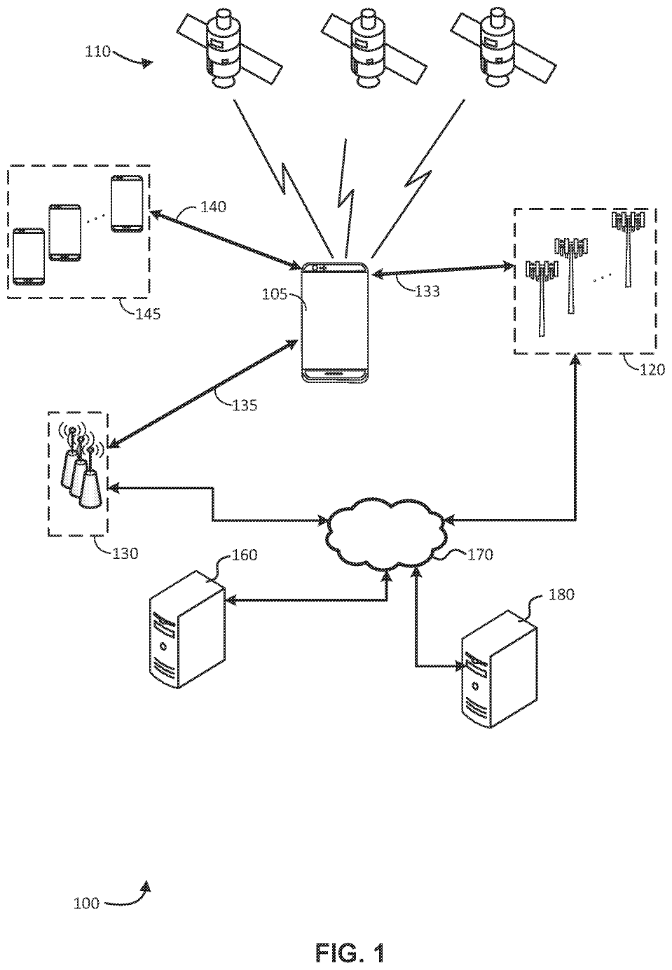

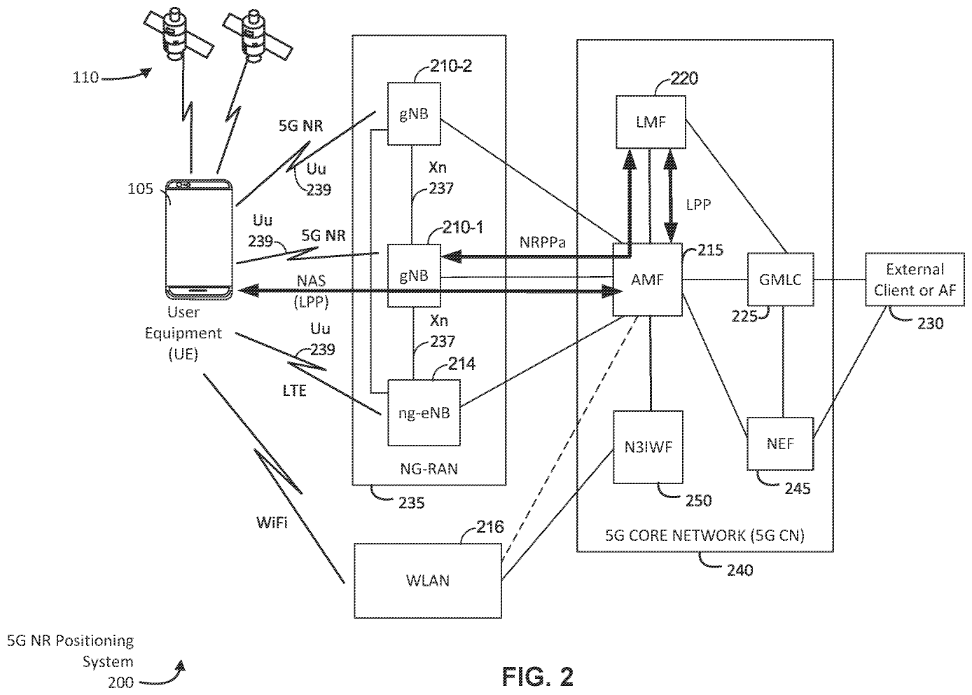

FIG. 1 is a simplified illustration of a positioning system 100 in which a UE 105, location server 160, and/or other components of the positioning system 100 can use the techniques provided herein for supporting positioning of a UE (e.g., UE 105) by grouping antennas, according to some embodiments. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be configured to be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs, e.g., with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAOA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or PRS transmitted on a sidelink (SL-PRS) by other UEs), which can be used for TDOA, AoD, and RTT measurements. Other reference signals that can be used for positioning (UL, DL, or DL-UL) may include Sounding Reference Signal (SRS, including, e.g., UL-SRS transmitted by UEs or SL-SRS transmitted on a sidelink to or by other UEs), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

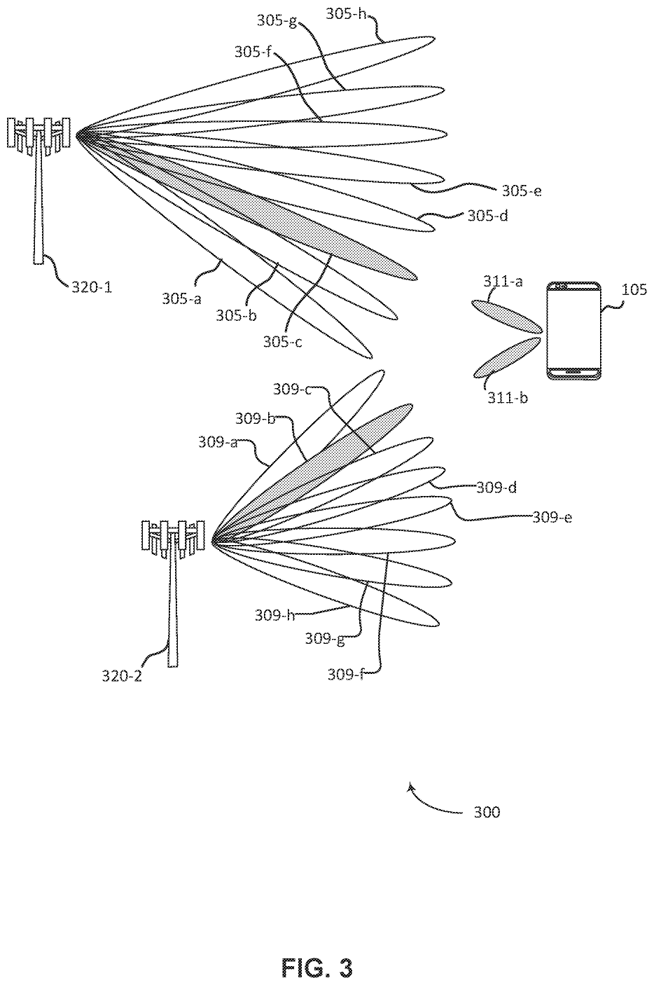

FIG. 3 is a diagram illustrating a simplified environment 300 including two TRPs 320-1 and 320-2 (which may correspond to base stations 120 of FIG. 1 and/or gNBs 210 and/or ng-eNB 214 of FIG. 2) with antenna arrays that can perform beamforming to produce directional beams for transmitting and/or receiving RF signals. FIG. 3 also illustrates a UE 105, which may also use beamforming for transmitting and/or receiving RF signals. Such directional beams are used in 5G NR wireless communication networks. Each directional beam may have a beam width centered in a different direction, enabling different beams of a TRP 320 to correspond with different areas within a coverage area for the TRP 320.

Different modes of operation may enable TRPs 320-1 and 320-2 to use a larger or smaller number of beams. For example, in a first mode of operation, a TRP 320 may use 16 beams, in which case each beam may have a relatively wide beam width. In a second mode of operation, a TRP 320 may use 64 beams, in which case each beam may have a relatively narrow beam width. Depending on the capabilities of a TRP 320, the TRP may use any number of beams the TRP 320 may be capable of forming. In some implementations, each antenna of a transmitter or receiver may be configured to form a corresponding beam. The modes of operation and/or number of beams may be defined in relevant wireless standards and may correspond to different directions in either or both azimuth and elevation (e.g., horizontal and vertical directions). Different modes of operation may be used to transmit and/or receive different signal types. Additionally or alternatively, the UE 105 may be capable of using different numbers of beams, which may also correspond to different modes of operation, signal types, etc.

In some situations, a TRP 320 may use beam sweeping. Beam sweeping is a process in which the TRP 320 may send an RF signal in different directions using different respective beams, often in succession, effectively “sweeping” across a coverage area. For example, a TRP 320 may sweep across 120 or 360 degrees in an azimuth direction, for each beam sweep, which may be periodically repeated. Each direction beam can include an RF reference signal (e.g., a PRS resource), where base station 320-1 produces a set of RF reference signals that includes Tx beams 305-a, 305-b, 305-c, 305-d, 305-e, 305-f, 305-g, and 305-h, and the base station 320-2 produces a set of RF reference signals that includes Tx beams 309-a, 309-b, 309-c, 309-d, 309-e, 309-f, 309-g, and 309-h. As noted, because UE 320 may also include an antenna array, it can receive RF reference signals transmitted by base stations 320-1 and 320-2 using beamforming to form respective receive beams (Rx beams) 311-a and 311-b. Beamforming in this manner (by base stations 320 and optionally by UEs 105) can be used to make communications more efficient. They can also be used for other purposes, including taking measurements for position determination (e.g., AoD and AoA measurements).

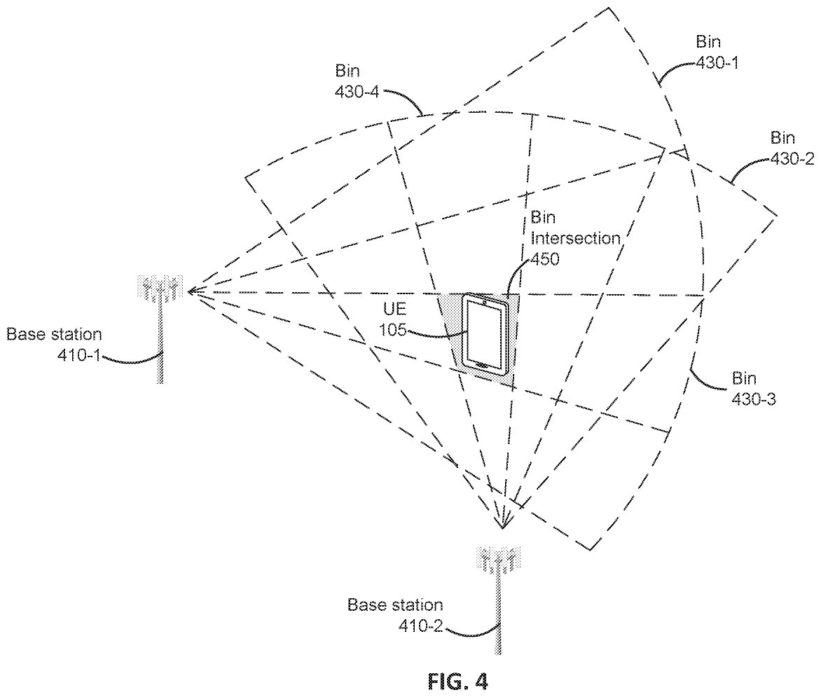

FIG. 4 is an illustration of how AoD-based positioning, e.g., in the downlink, can be performed, according to some embodiments. In brief, AoD-based positioning is positioning based on reference signals (e.g., PRS, including DL-PRS) received by the UE 105, transmitted by certain beams, antennas, or air interfaces of the base stations 410, and a corresponding coverage area covered by the beams.

In AoD-based positioning, a location server (e.g., location server 160 shown in FIG. 1) may provide AoD assistance data to a UE 105. This assistance data, which may be based on an approximate location of the UE 105, may provide information regarding reference signals for nearby base stations 310, including center channel frequency of each base station, various PRS configuration parameters (e.g., NPRS, TPRS, muting sequence, frequency hopping sequence, PRS ID, PRS bandwidth, beam ID), a base station (cell) global ID, PRS signal characteristics associated with a directional PRS, and/or other base station related parameters applicable to AoD or some other position method.

Using this information, the UE 105 and/or the location server can determine the UE's location by the beam(s) with which the UE 105 detects a PRS (e.g., DL-PRS) from each base station 410. More specifically, PRS from a base station 410 may be transmitted via a beam centered along angular regions, or bins 430-1, 430-2, 430-3, 430-4, etc. (collectively or individually referred to as bin(s) 430). Thus, each bin 430 can correspond to a PRS from a different respective beam. Bins 430 from different base stations 410 can form an angular grid that can be used to determine the location of the UE 105. For example, as illustrated in FIG. 4, bins of base station 410-1 including bins 430-1 and 430-3 intersect with bins of base station 410-2 including bin 430-2 and 430-4 to form an angular grid. The UE 105 can measure (e.g., using RSRP measurements) the PRS of different beams of each base station 410. These measurements can be used by the UE 105 or sent to the location server to determine the location of the UE 105 from the corresponding bin intersection 450, where the bin 430-3 corresponding to the PRS of a first base station 410-1 intersects with the bin 430-4 corresponding to the PRS of a second base station 410-2. Similar measurements can be made from additional base stations (not shown) to provide additional accuracy. Additionally or alternatively, measurements from multiple beams of a single base station 410 can enable interpolation for higher-resolution positioning. In some embodiments, AoD-based positioning may be performed in the uplink based on SRS sent from, e.g., a UE to a base station.

Furthermore, AoA-based positioning in the uplink or the downlink can be performed using these base stations 410, according to some embodiments. In brief, AoA-based positioning is positioning based on reference signals (e.g., SRS or PRS, including UL-PRS) received from the UE 105, received by certain beams, antennas, or air interfaces of the base stations 410, and a corresponding coverage area covered by the beams.

Furthermore, AoA- or AoD-based positioning in the uplink or the downlink can be performed between a target UE 105 and one or more anchor UEs (not shown), according to some embodiments. Positioning reference signals (e.g., SRS) may be received by the target UE 105 from the other UE on a sidelink. The target UE 105 may then measure SRS from certain beams of the anchor UE. In some cases, positioning reference signals (e.g., SRS) may be transmitted by the target UE 105 to the other UE on a sidelink.

Using this information, the UE 105 and/or the location server can determine the UE's location by the beam(s) with which the base stations 410 detects a PRS from the UE 105. A bin intersection 450 can be determined similar to the AoD-based positioning described above. Similar measurements can be made from additional base stations (not shown) to provide additional accuracy. Additionally or alternatively, measurements from multiple, more granular beams of a single base station 410 can enable interpolation for higher-resolution positioning.

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., NPRS, TPRS, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ−ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

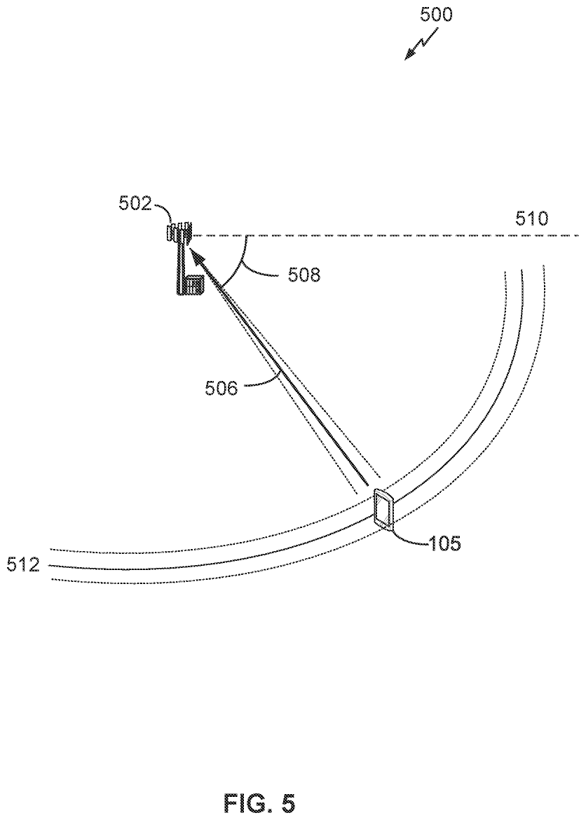

FIG. 5 illustrates an exemplary wireless communications system 500 implementing UE positioning using an AoA technique. In the example of FIG. 5, a base station 502 (which may be an example of gNB 210-1, 210-2) may generate an angle measurement 508 to be used in determining an estimate of the position of the UE 105 (which may be determined by the base station 502 or a location server 160). The UE 105 and base station 502 may communicate wirelessly, e.g., using RF signals and standardized protocols for the modulation of the RF signals and the exchange of information packets. By extracting different types of information from the exchanged RF signals, and utilizing the layout of the wireless communications system 500 including the base stations' locations, geometry, etc., the base station 502 may determine the position of the UE 105, or assist in the determination of its position, in a predefined reference coordinate system. In some embodiments, the position may be specified with reference to an angle measurement in a two-dimensional coordinate space (such as latitude and longitude); however, the embodiments disclosed herein are not so limited, and may also be applicable to determining angle measurements using a three-dimensional coordinate system (such as latitude, longitude, and elevation) if the extra dimension is desired. Additionally, while FIG. 5 illustrates one UE 105 and one base station 502, as will be appreciated, there may be more UEs 105 and more or fewer base stations 502 in certain embodiments.

For UL AoA based UE positioning, the UE 105 may transmit an SRS 506 to the base station 502. The base station 502 may receive the SRS 506 and generate an angle measurement 508 based on the SRS. For example, the base station 502 may use an antenna array to determine the direction from which the SRS 506 is received. In some embodiments, a reference axis 510 (which may be any suitable direction, such as true north for two-dimensional angles or perpendicular to the azimuth for three-dimensional angles) may be compared to the direction from which the SRS 506 is received to determine the angle measurement 508. The angle measurement 508 may be one or both of an AoA or ZoA of the SRS 506. Because of potential tolerances in the antenna components for receiving the SRS 506, the SRS 506 (which is measured as being received along the solid line for SRS 506) may be received slightly askew from the measured direction (such as within the cone between the dashed lines from the UE 105 to the base station 502). The difference between the angle measurement 608 and the actual angle (based on the actual direction) may be an angle error.

In some embodiments, the base station 502 may also determine the distance 512 or assist another device in determining the distance 512 (e.g., a location server 160 or another core network component). For example, the distance 512 may be based on RSTDs between reference signals from multiple sources or other ToA based measurements. In another example, the distance 612 may be determined using multiple angle measurements from different base stations receiving SRS 506 from the UE 105. Based on the known locations of the base stations and the multiple angle measurements, the distance 512 may be determined. Since the angle measurements may include some error, the distance 512 may include some error as depicted in dashed lines surrounding the solid line depicting the distance 512. The position of the UE 105 may be indicated with reference to a base station 502 (referred to as a local position or location) or may be indicated in an absolute manner (such as per latitude and longitude (and optionally elevation), referred to as a global position or location).

The operations for determining a position of a UE using DL AoA based UE positioning are similar to UL AoA based UE positioning. In such implementations using DL AoA, the UE 105 may receive PRS from a base station and generate (or assist in determining) an angle measurement based on the PRS.

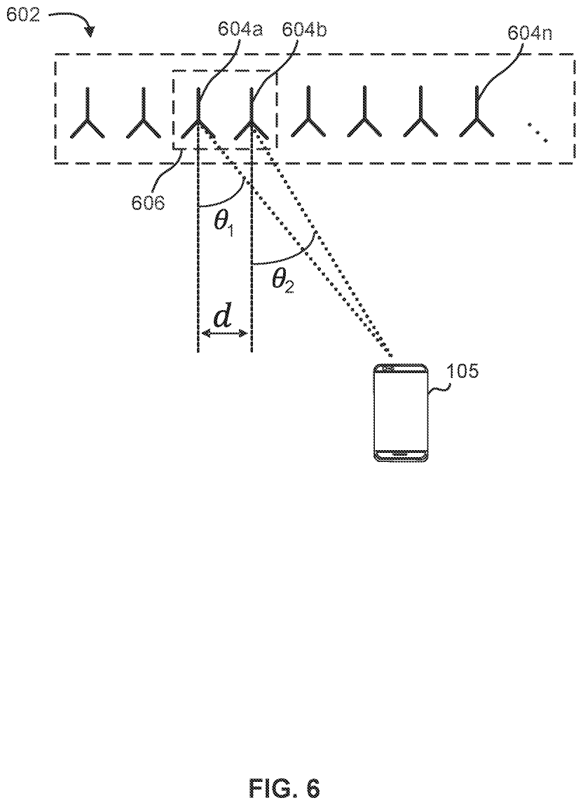

FIG. 6 illustrates an example of how the angle of departure (AoD) may be determined based on a phase difference between signals transmitted by antennas of a transmitter 602. In some embodiments, a transmitter 602 of a wireless-enabled device, such as a base station 130, includes multiple antennas (or antenna elements) 604a, 604b . . . 604n configured for communication (of, e.g., PRS) with a target UE 105. The transmitter 602 may have more or fewer antennas than shown in FIG. 6. In one example, the transmitter of a gNB may have 64 antennas. Further, antennas may be arranged differently than shown in FIG. 6, such as in a 2D array to allow for beamforming in three dimensions. In some embodiments, the transmitter may be that of a UE communicating with a base station, where the UE is configured to transmit, e.g., SRS to the base station.

In the illustrated configuration, the distance d between the antennas 604a, 604b is known. A phase difference Δϕ between signals transmitted from the antennas 604a, 604b is also known (assuming same signal frequency). From these two variables, the angle of departure (AoD) of a signal, e.g., 01, may be determined using the following equation:

$$θ = arc sin ( Δϕ \cdot λ / ( 2 π d ) ) \qquad ( Eqn . l )$$

In various embodiments, angles of arrival (AoA) may be determined in similar fashion, with d as the distance between receiving antennas and Δϕ as the phase difference between the signals received by multiple antennas.

In some embodiments, AoD and AoA may be determined and/or the position of the UE may be estimated in other ways, such as spectral estimation (e.g., spatial spectral estimation based on eigenanalysis of a spatial correlation matrix, including peak determination in the spatial spectrum associated with a signal source), or location fingerprinting (e.g., using a location-dependent information such as an AoA fingerprint, which may include, e.g., RSSI or received signal strength (RSS)). In some implementations, the above methods (including aforementioned phase-difference-based estimation) may be combined with a probabilistic approach or machine learning to increase the accuracy of the position estimation.

However, as noted above, phase noise may impair phase measurement. Hence, in the presence of phase noise, the phase @ (and by extension, phase difference Δϕ) may have bias or error, leading to less accurate determination of angle θ and thus less accurate measurements of the AoD. Solutions to mitigate the phase bias or error is needed.

As discussed in greater detail throughout the present disclosure, at least two of the antennas of a transmitter or a receiver may be grouped together into “phase-noise groups” (PNGs). One or more PNGs may be defined for the antennas 604a, 604b . . . 604n. A PNG may be defined based at least on a phase-based parameter correlated with an electromagnetic characteristic of the antennas 604a, 604b . . . 604n. Put another way, a PNG may be a subarray of antennas grouped according to at least a phase-based parameter. The electromagnetic characteristic may include, e.g., phase noise or relative phase. The phase-based parameter may include, e.g., phase bias, phase error, or phase error margin of antennas. The phase error margin, or the maximum difference of the phase bias, may depend on the frequency range, band, or band combinations of the antennas. These parameters may be affected by, e.g., phase noise. In the example shown in FIG. 6, antennas 604a and 604b may be associated with a PNG 606 on the basis of antennas 604a and 604b having, e.g., a common RF signal source.

These phase-based parameters may arise from the aforementioned phase noise, which may be introduced by, e.g., variations in RF signal sources and variations in RF quartz crystals. Defining a PNG where a group of antennas share a common or similar phase bias or error may minimize phase noise or variations in phase within that group of antennas (i.e., PNG). In some scenarios, the PNG-related procedures may be useful for channel estimation for data communications to combat the impact from phase noise. In some embodiments, PNGs may therefore be defined based on antennas sharing a common RF source.

While antennas may become associated with certain PNGs, not all PNGs may be used for sending or receiving positioning signals. In some implementations, some PNGs may be excluded from use (e.g., transmission of SRS) if determined to have greater phase noise margin than other PNGs or than an acceptable level. In some implementations, some PNGs may be weighted differently depending on their phase noise or error. Weights may be used to, e.g., rank the PNGs or assign priorities to them when selecting which PNGs to use.

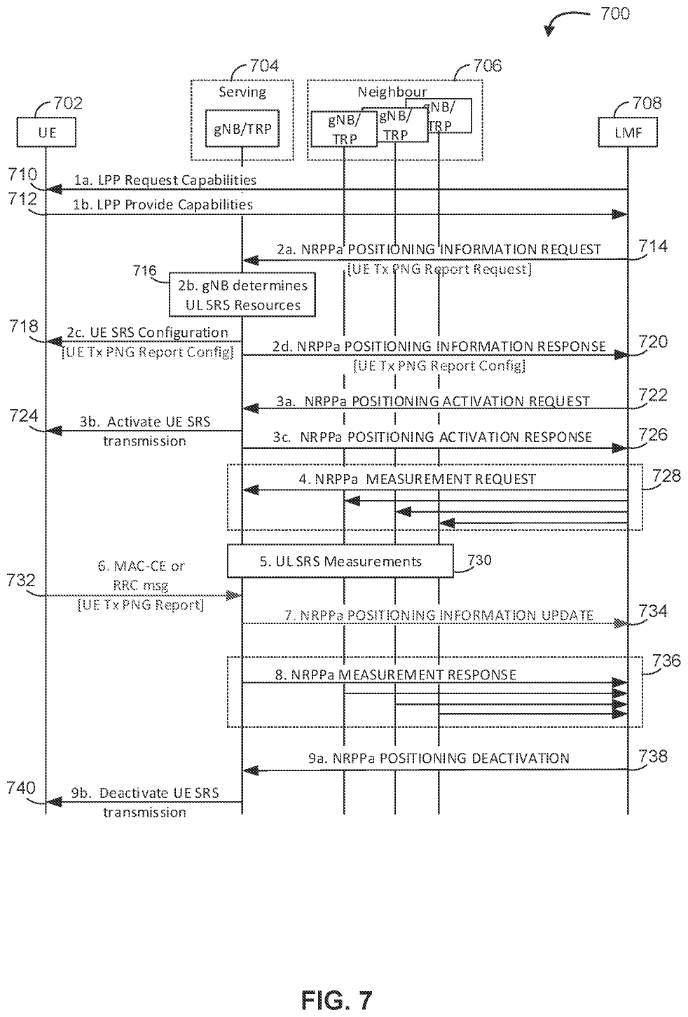

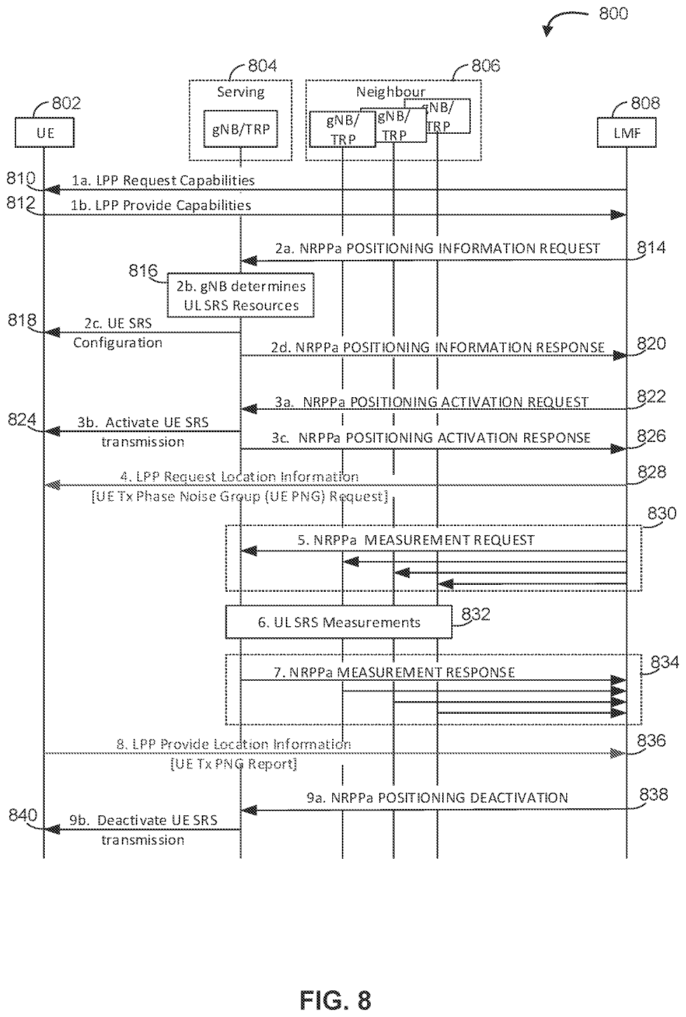

The transmitter as shown in FIG. 6 may be at a UE or a base station (e.g., gNB). In some embodiments, the PNG defined for antennas of the transmitter is known by the device implementing the transmitter. On the other hand, a receiver (configured to receive positioning signals from the transmitter) may obtain PNG configurations by obtaining information about the PNG of the transmitter through a server (e.g., LMF) which in turn may obtain the information through reporting from the transmitter device. As an example, the UE may have one or more PNGs defined for its transmitter. The UE may send a message to the LMF with a report containing information on the PNGs. The receiver at a base station may then obtain the information on the PNGs, which may be useful for uplink measurements (of SRS for example). In some embodiments, the PNG grouping may be defined as associations between antenna groups (PNGs) and PNG identifiers (PNG IDs) associated with respective PNGs. Additional details follow in the context of call flows illustrated in FIGS. 7 and 8.

FIG. 7 illustrates a diagram of a call flow 700 for a positioning procedure using a wireless network such as that shown in FIGS. 1 and 2, according to some embodiments. Signals may be exchanged among a target UE 702, a serving gNB 704, one or more other gNBs 706 (including those neighboring and/or communicative with the serving gNB), and an LMF 708. The LMF 708 may be an example of the LMF 220 shown in FIG. 2. In some embodiments, each of the serving gNB 704 and the gNBs 706 may be an example of gNBs 210-1 or 210-2 of an NG-RAN as shown in FIG. 2, or any additional gNBs not shown in FIG. 2. In some embodiments, at least some of the gNBs 706 may be a serving gNB capable of performing the same operations performed by the serving gNB 704 with respect to the LMF 708 and the target UE 702 as discussed below.

Each of the serving gNB 704 and the target UE 702 may comprise multiple physical antennas that are configured to transmit and receive positioning signals via phase-based grouping of antennas. In some embodiments, the serving gNB 704 may be an example of a base station configured to serve as a transmitter in a DL transmission or a receiver in an UL transmission. In some embodiments, the UE 702 may be configured to serve as a receiver in a DL transmission or a transmitter in an UL transmission. In one example of a DL transmission, the serving gNB 704 may transmit downlink positioning signals (e.g., DL-PRS) to the target UE 702 and perform AoD measurements. In another example of a DL transmission, the target UE 702 may receive downlink positioning signals (e.g., DL-PRS) from the serving gNB 704 and perform AoA measurements. In one example of an UL transmission, the serving gNB 704 may receive uplink positioning signals (e.g., UL-SRS) from the target UE 702 and perform AoA measurements. In another example of an UL transmission, the target UE 702 may transmit uplink positioning signals (e.g., UL-SRS) to the serving gNB 704 and perform AoD measurements. Call flow 700 illustrates an example of UL transmission and AoD measurements from the target UE 702 to the serving gNB 704.

At arrow 710 of the call flow, the LMF 708 may request positioning capabilities from the target UE 702. In some embodiments, the LMF may send a message to the target UE and may indicate the types of LPP-related capability needed.

At arrow 712 of the call flow, the target UE 702 may respond with a message containing LPP-related capabilities, including capabilities that correspond to any capability types specified in the message from the LMF in arrow 710. The target UE may indicate whether it supports a particular positioning method (e.g., AoD, AoA, TDOA).

At arrow 714 of the call flow, the LMF may request configuration information for the target UE from the serving gNB 704. In some embodiments, the LMF may send an NRPPa Positioning Information Request message to the serving gNB. In some implementations, the request may include a report request for the target UE, where requested configuration information pertains to a group or groups of antennas, e.g., the target UE's PNGs. As previously noted, a PNG may refer to a group of antennas (e.g., at the UE) that share a similar phase-based parameter correlated with an electromagnetic characteristic of antennas. Defining a PNG for a UE where a group of antennas share a common or similar phase bias or error may minimize phase noise or variations in phase within that group of antennas (PNG).

In some embodiments, the requested information may include an association with antennas and PNG IDs. In some embodiments, the request may be on a periodic basis, occurring at predetermined or dynamic intervals. In some embodiments, the request may be one time.

In some embodiments, the requested configuration information may include the target UE's PNG capabilities, e.g., whether the target UE's may support multiple PNGs, the number of PNGs supported, etc.

In some embodiments, the LMF may request that the target UE use specific PNGs. In some implementations, a machine learning algorithm may be utilized by the LMF or the target UE to select the PNGs, e.g., based on a reliability factor. In some implementations, some PNGs may be excluded from use in transmission of positioning signals (or receipt thereof). In some implementations, one or more PNGs may be given respective weights and ranked accordingly when selecting PNGs to use. The LMF may also provide any assistance data usable by the serving gNB, e.g., identity of target UE, pathloss reference, spatial relation, Synchronization Signal Block (SSB) configuration.

At block 716 of the call flow, the serving gNB may determine UL-SRS resources, resource availability, and/or configuration information according to the request from arrow 714.

At arrow 718 of the call flow, the target UE may be configured with one or more UL-SRS resource sets based on the determination of the resources available at block 716.

In some embodiments, the serving gNB may configure the target UE with the UL-SRS resource sets. In some embodiments, these resources may include time and/or frequency resources (e.g., resource blocks, resource elements, etc. of an orthogonal frequency-division multiplexing (OFDM) or other communication scheme) that may be used to transmit the UL-SRS to the serving gNB. Once the serving gNB determines which resources the target UE could use for transmitting the UL-SRS, the serving gNB may configure the target UE for communication, e.g., by including the configuration information in signals or data for the target UE, such that the target UE will be aware when and how to transmit the UL-SRS to the serving gNB. The serving gNB may then provide the configuration information to the target UE (as part of arrow 718) and/or the LMF (at arrow 720).

In some embodiments, the target UE may configure itself (e.g., for transmission of UL-SRS) to use specific groups of antennas associated with one or more PNG IDs based on known parameters (e.g., distances d and phase differences Δϕ). In some embodiments, the LMF may request the target UE to use specific groups of antennas (PNGs) associated with one or more PNG IDs.

At arrow 722, the LMF may request the serving gNB to activate the positioning process at the target UE by sending a message to the serving gNB. For example, the target UE may be instructed by the serving gNB to transmit signals (e.g., UL-SRS). At arrow 724, the gNB may then activate the positioning process in response to the request. For example, the gNB may send a message to the target UE, causing transmission of UL-SRS at the target UE. At arrow 726, the gNB may report the activation of the positioning process back to the LMF.

At arrows 728, the LMF may select one or more candidate gNBs including the serving gNB, and provide them configuration information for positioning signal measurements (e.g., UL-SRS configuration). In some embodiments, the LMF may send an NRPPa Measurement Request message to the selected gNBs to provide the configuration information. The messages with the configuration information may include information required to, at block 730, enable the gNBs to perform uplink measurements with respect to the target UE.

At block 730, at least the serving gNB may perform uplink measurements, e.g., based on UL-SRS received from the target UE. At this point, the AoD of positioning signals from the target UE to the serving gNB may be measured at the target UE, where the signals include the UL-SRS. In some embodiments, the AoA of signals received at the serving gNB may be measured at the serving gNB. UL-SRS may be sent by a specific PNG, a group of antennas at the target UE selected by, e.g., the target UE or the LMF. Known distance(s) d between antennas of the PNG and phase difference(s) Δϕ between reference signals transmitted from the antennas of the PNG may be used to determine the AoD or the AoA (see Eqn. 1).

In some embodiments (not shown in the call flow 700), DL-PRS may be sent by a specific PNG at the serving gNB, selected by the gNB or the LMF.

The uplink measurements may be accompanied by arrow 732 (e.g., reporting supported PNGs) and arrow 734. At arrow 732, the target UE may send a message reporting its capabilities regarding whether it supports multiple PNGs. In some embodiments, the target UE may report its capabilities to the serving gNB in a report. In some embodiments, the target UE may report its capabilities directly to the LMF, e.g., via the serving gNB or another gNB (see also FIG. 8). In some embodiments, the target UE may include the number or quantity of PNGs it supports. In some embodiments, the serving gNB may perform uplink measurements (additional to those at block 730) based on the obtained report.

In some embodiments, each PNG is assigned an identifier (ID). The ID may be unique to the PNG such that the PNG is identifiable by a base station (e.g., serving gNB) when performing AoD or AoA, or by the LMF (e.g., for informing a base station). Being capable of supporting multiple PNGs (antennas in multiple groups) may indicate the target UE's capability to transmit the SRS with different sub-arrays with different RF sources.

If there are multiple PNGs reported by the target UE, the target UE may be configured to provide to the serving gNB and/or to the LMF information describing associations of PNG IDs with specific antennas utilized by the target UE or specific antennas within one or more subarrays. For example, for a four-antenna transmitter at the UE, first and second antennas may be associated with ID=1, and third and fourth antennas may be associated with ID=2.

In some embodiments, one SRS resource may be associated with multiple PNGs. For example, multiple PNG IDs may be allocated to one resource block (RB). In some embodiments, multiple SRS transmissions may be associated with different PNG IDs, where the multiple transmission have the same timestamp or different timestamps. Multiple SRS resources may be allocated to respective SRS transmissions and/or PNG IDs. In some implementations, transmission that occur at different timestamps may be associated with different PNG IDs from the same subarray.

In some embodiments, the target UE may include in the report a range of error in the relative phases between antennas in each PNG. The range of error may be used by the serving gNB and/or the LMF to be informed of residual errors that may still be present despite, e.g., the common RF signal source. The range of error may be determined at deployment, or through calibration. In some cases, the range of error representing residual errors may be used to confirm or verify that the group of antennas in the PNG is appropriate; a group of antennas having widely varying phase differences may require reconsideration by the target UE.

In some embodiments, if the PNG ID(s) are not reported, the serving gNB and/or the LMF may assume that all the antennas or antennas arrays of the target UE have the same RF signal source. If multiple PNG IDs are reported, the serving gNB and/or the LMF may determine reliability factors indicative of which PNGs are more reliable, e.g., based on an error measurement, or a preconfigured algorithm such as a machine learning algorithm assuming the dataset of the reported measurement, the phase-based parameter associated with the PNG, and/or resulting positioning is sufficiently large. For instance, the gNB and/or the LMF may predict an accuracy of a position measurement using a regression algorithm based on previously obtained parameters (including phase-based parameters), precision (consistency of resulting positions) and/or accuracy (closeness of resulting positions to actual position) of the measurements for the positioning of the UE. In some implementations, to accurately estimate the phase noise bias, a reference device (e.g., a Positioning Reference Unit) may identify the PNGs across different combination of antennas.

At arrow 734, the serving gNB may send a NRPPa message to the LMF to provide a positioning information update based on, e.g., the target UE's message from arrow 732 (including the capability report). The update may include, e.g., the PNG report, including capabilities of the target UE with respect to PNGs, PNG IDs, SRS resources, the number of PNGs supported by the target UE, etc.

At arrows 736, gNBs may report uplink measurements to the LMF, including measurements obtained by the serving gNB at block 730.

At arrow 738, the LMF may send an NRPPa message to the serving gNB with instructions to deactivate positioning once UL-SRS measurements and positioning (e.g., using PNG-based AoD or AoD) are complete. In response, at arrow 740, the serving gNB may deactivate further UL-SRS transmissions from the UE, e.g., by sending a message to the target UE.

Thus, the call flow 700 supports positioning of a target UE 702 by defining and establishing PNGs (e.g., at arrow 732) by grouping antennas at the target UE based on aforementioned parameters (e.g., phase bias, phase error, and/or phase error margin of antennas). SRS and PRS may be transmitted to a receiver from the selected or requested PNG(s), and AoD or AoA measurements may be made based on such transmissions, which are herein referred to as PNG-based transmissions and PNG-based measurements, respectively. The above call flow may enable various PNG-based measurements according to different implementations.

In some implementations, the target UE may perform PNG-based AoD measurements as described above by transmitting UL-SRS to a base station (e.g., at a receiver of a gNB) with the antennas of the target UE's selected or requested PNG(s) configured as discussed above. In some implementations, the target UE may perform PNG-based AoA measurements by receiving DL-PRS from the base station at the target UE's PNGs.

In some cases, the base station (e.g., the serving gNB) may define one or more PNGs for its antennas. In some implementations, the base station may perform PNG-based AoD measurements by transmitting DL-PRS to the target UE using antennas of selected or requested PNG(s) of the base station. In some implementations, the base station may perform PNG-based AoA measurements by receiving UL-SRS at the base station's PNG(s) from the target UE.

In some implementations, a peer (or anchor) UE different from the target UE may define one or more PNGs for its antennas. PNG-based peer-to-peer sidelink transmission may be enabled thereby. In this case, the peer UE may transmit SL-PRS to the target UE using antennas of the selected or requested PNG(s) of the peer UE. In some implementations, the peer UE may perform PNG-based AoD measurements by transmitting SL-PRS to the target UE with the antennas of the peer UE's PNGs. In some implementations, the peer UE may perform PNG-based AoA measurements by receiving SL-PRS from the target UE at the peer UE's PNGs.

FIG. 8 illustrates a diagram of another call flow 800 for a positioning procedure using a wireless network such as that shown in FIGS. 1 and 2, according to some embodiments. Signals may be exchanged among a target UE 802, a serving gNB 804, one or more other gNBs (including those neighboring the serving gNB) 806, and an LMF 808. The LMF 808 may be an example of the LMF 220 as shown in FIG. 2. In some embodiments, each of the serving gNB 804 and the one or more gNBs 806 may be an example of gNBs 210-1, 210-2 of an NG-RAN as shown (and any additional gNBs not shown) in FIG. 2. In some embodiments, the serving gNB 804 may be an example of the serving gNB 704 of FIG. 7. In some embodiments, at least some of the one or more gNBs 806 and/or other gNBs not shown in FIG. 8 may be a serving gNB capable of performing the same operations performed by serving gNB 804 as discussed below with respect to the LMF 808 and the target UE 802.

According to various embodiments, actions (arrows and block) 810-826 may correspond to actions 710-726 as discussed with respect to FIG. 7.

At arrow 828, the LMF may on-demand request the target UE to transmit UL-SRS with antennas associated with one or more PNG IDs. The LMF may not be aware of the antenna configuration at the target UE, but may be aware of the mapping between the antennas and PNG IDs. For example, a first group of antennas may be associated with ID=1, a second group of antennas may be associated with ID=2, and so on. Since a specific PNG ID may be associated with a specific subarray of antennas, the request by the LMF may be equivalent to requesting UL-SRS transmit with a specific subarray. In some implementations, the on-demand request from the LMF may also include the timestamp or time window for the PNG-specific transmission. In some implementations, the selection of PNGs may alternatively or additionally be based on an algorithm executable on the LMF or another location server. The algorithm may be, for example, a machine learning algorithm configured to predict a reliability of the position measurement, as discussed above.

At arrows 830, the LMF may select one or more candidate gNBs including the serving gNB, and provide them the configuration information (e.g., UL-SRS configuration), as in arrows 728.

At arrow 832, at least the serving gNB may perform uplink measurements, e.g., based on UL-SRS received from the target UE, as in block 730. At this point, the AoD of positioning signals from the target UE to the serving gNB may be measured at the target UE, where the signals include the UL-SRS. In some embodiments, the AoA of signals received at the serving gNB may be measured at the serving gNB. In some implementations, UL-SRS may be sent by a specific PNG at the UE. In some implementations (not shown in FIG. 8), DL-PRS may be sent by a specific PNG at the serving gNB.

At arrows 834, each applicable gNB may report uplink measurements to the LMF, i.e., those measurements obtained by gNBs at arrow 832.

At arrow 836, the target UE may send a message reporting its capabilities regarding whether it supports multiple PNGs. In some embodiments, the target UE may report its capabilities directly to the LMF, e.g., via the serving gNB or another gNB. The message may include location information of the UE, determined via the PNG-based AoD or AoA measurements at arrow 832.

At arrow 838, the LMF may send an NRPPa message to the serving gNB with instructions to deactivate positioning once UL-SRS measurements and positioning (e.g., using PNG-based AoD or AoD) are complete. In response, at arrow 840, the serving gNB may deactivate further UL-SRS transmissions from the UE, e.g., by sending a message to the target UE.

Thus, the call flow 800 supports positioning of a target UE 702 by defining and establishing PNGs (e.g., at arrow 828) by grouping antennas at the target UE based on aforementioned parameters (e.g., phase bias, phase error, and/or phase error margin of antennas).

According to varying implementations of call flows 700 or 800, (1) a target UE may perform PNG-based AoD measurements by transmitting UL-SRS with the antennas of the target UE's selected or requested PNG(s) to a base station (e.g., at a receiver of a gNB), (2) a base station (e.g., the serving gNB) may perform PNG-based AoA measurements by receiving UL-SRS at the base station's PNG(s) from the target UE, (3) the base station may perform PNG-based AoD measurements by transmitting DL-PRS from the base station's PNGs to the target UE, or (4) the target UE may perform PNG-based AoA measurements by receiving DL-PRS at the target UE's PNGs from the base station. In addition, PNG-based peer-to-peer sidelink transmission may be performed in which (5) a peer (or anchor) UE may transmit SL-PRS to the target UE using antennas of the selected or requested PNG(s) of the peer UE, or (6) the peer UE may perform PNG-based AoD measurements by transmitting SL-PRS to the target UE with the antennas of the peer UE's PNGs.

### Methods

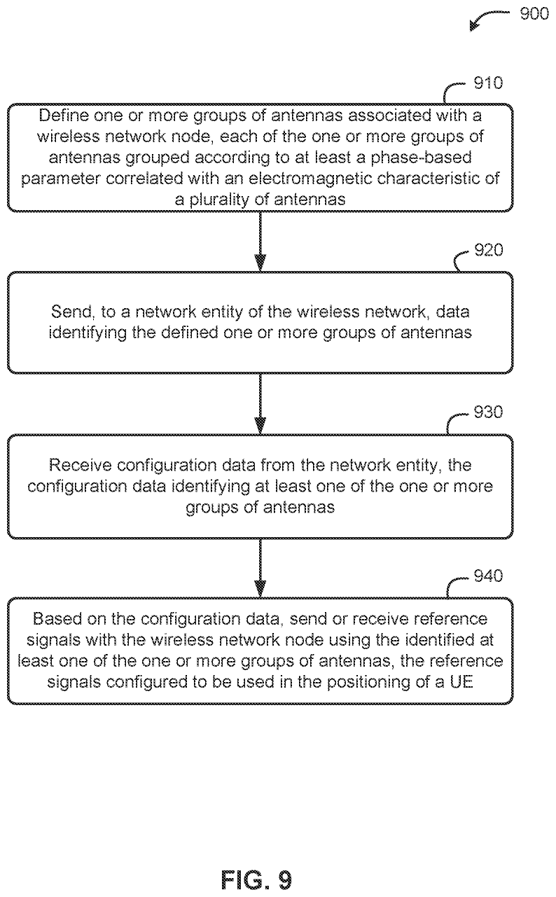

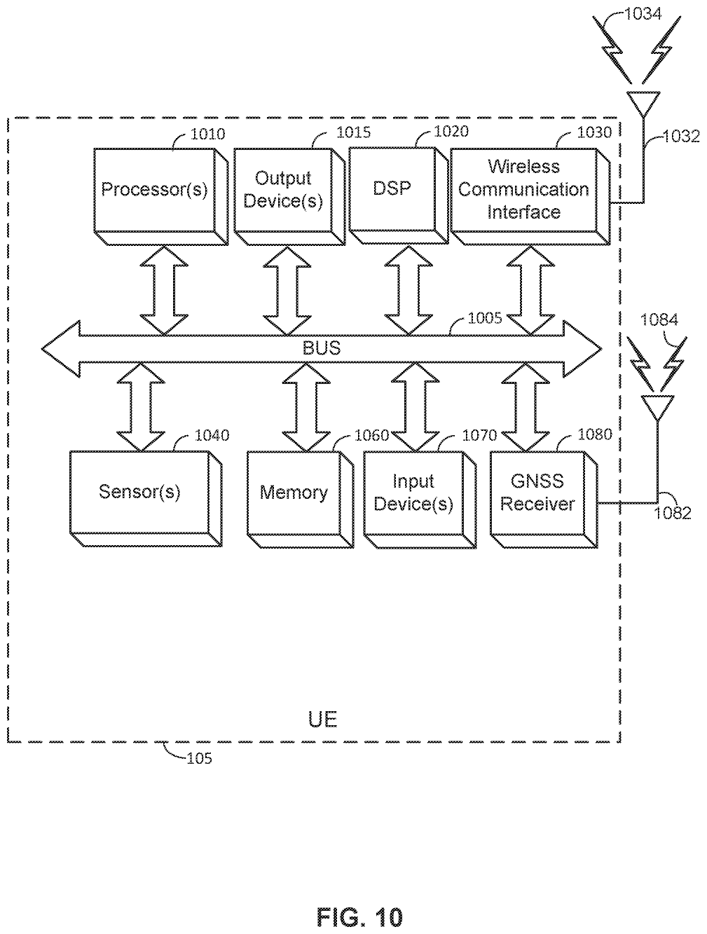

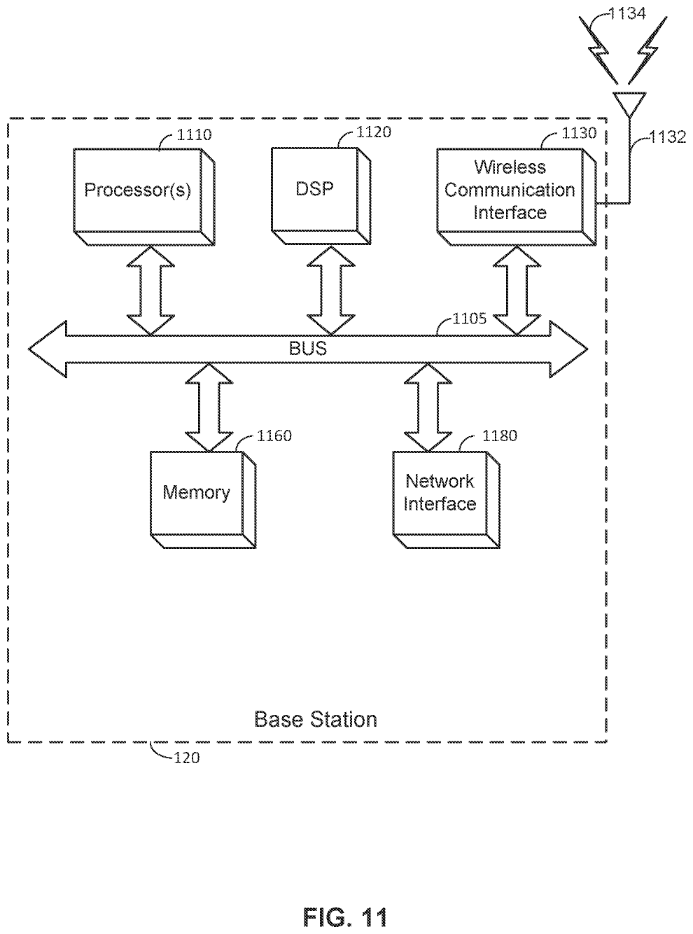

FIG. 9 is a flow diagram of a method 900 for supporting positioning of a user equipment (UE) in a wireless network. Means for performing the functionality illustrated in one or more of the blocks shown in FIG. 9 may be performed by hardware and/or software components of a computerized apparatus such as a UE (e.g., a target UE, peer UE) or a base station (e.g., gNB). Example components of a UE are illustrated in FIG. 10, which is described in more detail below. Example components of a base station are illustrated in FIG. 11, which is described in more detail below.

In some aspects, a computer-readable apparatus including a storage medium may store computer-readable and computer-executable instructions that are configured to, when executed by at least one processor apparatus, cause the at least one processor apparatus or another apparatus (e.g., the UE or at least a portion of the base station) to perform the operations of the method 900.

It also should be noted that the operations of the method 900 may be performed in any suitable order, not necessarily the order depicted in FIG. 9. Further, the method 900 may include additional or fewer operations than those depicted in FIG. 9 to accomplish the supporting of the positioning of the UE.

At block 910, the method 900 may include defining one or more groups of antennas associated with a wireless network node. In some embodiments, each of the one or more groups of antennas may be a subset of a plurality of antennas associated with the wireless network node. In some embodiments, a group of antennas may include all of the plurality of antennas of the wireless network node.

In some embodiments, the wireless network node may include a target UE (e.g., UE 105). In some cases, the wireless network node may include a peer (or anchor) UE, a UE that is configured for wireless communication with the target UE (for, e.g., peer-to-peer sidelink communications). In some embodiments, the wireless network node may include a base station (e.g., base station 130, gNB 210, serving gNB 704). Hence, the PNGs may be associated with the antennas of a UE or the antennas of a base station.

In some embodiments, the one or more of antennas are defined as one or more corresponding phase-noise groups (PNGs). Each of the one or more groups of antennas (or PNGs) may be grouped according to at least a phase-based parameter correlated with an electromagnetic characteristic of a plurality of antennas. In some embodiments, the phase-based parameter may include, e.g., phase bias, phase error, or phase error margin of antennas. In some embodiments, the electromagnetic characteristic of the plurality of antennas may include, e.g., phase noise or relative phase. Such electromagnetic characteristics may be caused by, e.g., antennas having a common RF signal source, or antennas having similar variations in hardware, e.g., RF quartz crystals having similar tolerances. The foregoing phase-based parameters (e.g., phase error) may be caused by the electromagnetic characteristic (e.g., phase noise).

That is, certain antennas may have similar phase-based parameters because they have, e.g., a common RF signal source. By grouping antennas that have a similar phase-based parameter (e.g., phase error), AoD and AoA measurements may possess greater accuracy and precision, based on the dependency of phase difference Δϕ between reference signals transmitted from the antennas. More precisely, the derivation of the angles may become more accurate by lowering the error in the phase difference (see Eqn. 1).

Means for performing functionality at block 910 may comprise one or more components (e.g., processor) of a UE or a base station as illustrated in FIGS. 10 and 11.

At block 920, the method 900 may include sending, to a network entity of the wireless network, data identifying the defined one or more groups of antennas.

In some embodiments, the network entity may include a base station (e.g., gNB). In some embodiments, the network entity may include an LMF, and the data identifying the defined one or more groups of antennas may be sent with (e.g., from a base station) or via a base station (e.g., from a target UE). In some implementations, the network entity may request “on demand” for the data identifying the defined one or more groups of antennas (PNGs). In some implementations, the data may be sent periodically.

In some embodiments, the data may include information regarding the antennas at the transmitter of the wireless network node (e.g., gNB, UE) sending positioning signals (including phases and phase differences of reference signals, physical distances of antennas), the antennas at the receiver of the wireless network node (e.g., gNB, UE) receiving positioning signals, RF signal source, PNGs that have been defined for the antennas, PNG IDs that are associated with the defined PNGs, capability of the wireless network node indicative of whether it supports usage of multiple groups of antennas (e.g., PNGs grouped according to at least the phase-based parameter), number of PNGs supported, range of error in phases, timestamps of positioning signals, and/or resources allocated for positioning signals.

Means for performing functionality at block 920 may comprise one or more components (e.g., processor, wireless communication interface) of a UE or a base station as illustrated in FIGS. 10 and 11.

At block 930, the method 900 may include receiving configuration data from the network entity, the configuration data identifying at least one of the one or more groups of antennas. In some embodiments, the gNB or the LMF may configure the UE to use specific groups of antennas, e.g., associated with specific PNG IDs. This information may be included in the configuration data.

Means for performing functionality at block 930 may comprise one or more components (e.g., processor, wireless communication interface) of a UE or a base station as illustrated in FIGS. 10 and 11.

At block 940, the method 900 may include, based on the configuration data, sending or receiving reference signals with the wireless network node using the identified at least one of the one or more groups of antennas, the reference signals configured to be used in the positioning of the UE. In some embodiments, the reference signals may be sent to the wireless network node. In some embodiments, the reference signals may be received from the wireless network node. In some embodiments, the reference signals may include PRS (e.g., DL-PRS, SL-PRS). In some embodiments, the reference signals may include SRS (e.g., UL-SRS, SL-SRS).

The reference signals may be sent or received using the requested PNG(s). As an example, DL-PRS may be transmitted from the base station to the target UE using one or more PNGs defined at the base station, enabling the base station to perform downlink AoD measurements, or enabling the target UE to receive DL-PRS and perform downlink AoA measurements, to assist in determining the target UE's position. Given known information regarding distance (d) between antenna elements of the PNG (e.g., between two antennas within a group of antennas), and phase difference (Δϕ) between reference signals sent (or received) by a PNG, angles of departure (or arrival) may be estimated or determined with greater accuracy than without grouping the antennas according to a phase-based parameter correlated with an electromagnetic characteristic. See above discussion with respect to FIG. 6 and Eqn. 1. Put another way, the positioning of the UE may be based on the AoD or AoA, where the AoD or AoA (and by extension, the positioning of the UE) is based at least on (i) the distance (d), and (ii) phases associated with the reference signals (e.g., phase difference between the reference signals). In some implementations, the sending or receiving of the reference signals may be based on the request from the network entity.

As another example, UL-SRS may be transmitted from the target UE to the base station using one or more PNGs defined at the target UE, enabling the target UE to perform uplink AoD measurements, or enabling the base station to receive UL-SRS perform uplink AoA measurements, to assist in determining the target UE's position.

In some scenarios, SL-PRS may be transmitted from a peer (or anchor) UE to the target UE using one or more PNGs defined at the peer UE, enabling the peer UE to perform sidelink AoD measurements, or enabling the target UE to receive the SL-PRS to perform sidelink AoA measurements, to assist in determining the target UE's position. In some scenarios, SL-SRS may be transmitted from the target UE to the peer UE using one or more PNGs defined at the target UE, enabling the target UE to perform sidelink AoD measurements or the peer UE to perform AoA measurements.

In some embodiments, a transmitter may send reference signals for calibration. A reference receiver (e.g., a Positioning Reference Unit) may be used which feeds back performance about the errors in the relative phases. In some cases, multiple receivers may participate in the calibration where the results from multiple receivers are processed. The feedback data collected from the reference receiver may be included in a dataset for use with, e.g., the aforementioned machine learning algorithm to determine, estimate, or predict PNG reliability, and thereby enhance positioning results.

In some embodiments, the identified at least one group of antennas may have been selected based on a reliability factor. The reliability factor may be determined by a machine learning algorithm as noted previously. Such a machine learning algorithm may be applied to the data identifying the defined one or more groups of antennas (from block 920).

Means for performing functionality at block 940 may comprise one or more components (e.g., processor, wireless communication interface) of a UE or a base station as illustrated in FIGS. 10 and 11.

### Apparatus

FIG. 10 is a block diagram of an embodiment of a UE 105, which can be utilized as described herein above (e.g., in association with FIGS. 7-9). For example, the UE 105 can perform one or more of the functions of the method shown in FIG. 9. It should be noted that FIG. 10 is meant only to provide a generalized illustration of various components, any or all of which may be utilized as appropriate. It can be noted that, in some instances, components illustrated by FIG. 10 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 10.

The UE 105 is shown comprising hardware elements that can be electrically coupled via a bus 1005 (or may otherwise be in communication, as appropriate). The hardware elements may include a processor(s) 1010 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1010 may comprise one or more processing units, which may be housed in a single integrated circuit (IC) or multiple ICs. As shown in FIG. 10, some embodiments may have a separate DSP 1020, depending on desired functionality. Location determination and/or other determinations based on wireless communication may be provided in the processor(s) 1010 and/or wireless communication interface 1030 (discussed below). The UE 105 also can include one or more input devices 1070, which can include without limitation one or more keyboards, touch screens, touch pads, microphones, buttons, dials, switches, and/or the like; and one or more output devices 1015, which can include without limitation one or more displays (e.g., touch screens), light emitting diodes (LEDs), speakers, and/or the like.

The UE 105 may also include a wireless communication interface 1030, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1030 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1032 that send and/or receive wireless signals 1034. According to some embodiments, the wireless communication antenna(s) 1032 may comprise a plurality of discrete antennas, antenna arrays, or any combination thereof. The antenna(s) 1032 may be capable of transmitting and receiving wireless signals using beams (e.g., Tx beams and Rx beams). Beam formation may be performed using digital and/or analog beam formation techniques, with respective digital and/or analog circuitry. The wireless communication interface 1030 may include such circuitry.

Depending on desired functionality, the wireless communication interface 1030 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1040. Sensor(s) 1040 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1080 capable of receiving signals 1084 from one or more GNSS satellites using an antenna 1082 (which could be the same as antenna 1032). Positioning based on GNSS signal measurement can be utilized to complement and/or incorporate the techniques described herein. The GNSS receiver 1080 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1080 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1080 is illustrated in FIG. 10 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1010, DSP 1020, and/or a processor within the wireless communication interface 1030 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1010 or DSP 1020.

The UE 105 may further include and/or be in communication with a memory 1060. The memory 1060 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1060 of the UE 105 also can comprise software elements (not shown in FIG. 10), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1060 that are executable by the UE 105 (and/or processor(s) 1010 or DSP 1020 within UE 105). In some embodiments, then, such code and/or instructions can be used to configure and/or adapt a general-purpose computer (or other device) to perform one or more operations in accordance with the described methods.

FIG. 11 is a block diagram of an embodiment of a base station 120, which can be utilized as described herein above (e.g., in association with FIGS. 7-9). For example, the base station 120 (e.g., gNB) can perform one or more of the functions of the method shown in FIG. 9. It should be noted that FIG. 11 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1105 (or may otherwise be in communication, as appropriate). The hardware elements may include a processor(s) 1110 which can include without limitation one or more general-purpose processors, one or more special-purpose processors (such as DSP chips, graphics acceleration processors, ASICs, and/or the like), and/or other processing structure or means. As shown in FIG. 11, some embodiments may have a separate DSP 1120, depending on desired functionality. Location determination and/or other determinations based on wireless communication may be provided in the processor(s) 1110 and/or wireless communication interface 1130 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1130, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1130 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1132 that send and/or receive wireless signals 1134.

The base station 120 may also include a network interface 1180, which can include support of wireline communication technologies. The network interface 1180 may include a modem, network card, chipset, and/or the like. The network interface 1180 may include one or more input and/or output communication interfaces to permit data to be exchanged with a network, communication network servers, computer systems, and/or any other electronic devices described herein.

In many embodiments, the base station 120 may further comprise a memory 1160. The memory 1160 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1160 of the base station 120 also may comprise software elements (not shown in FIG. 11), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1160 that are executable by the base station 120 (and/or processor(s) 1110 or DSP 1120 within base station 120). In some embodiments, then, such code and/or instructions can be used to configure and/or adapt a general-purpose computer (or other device) to perform one or more operations in accordance with the described methods.

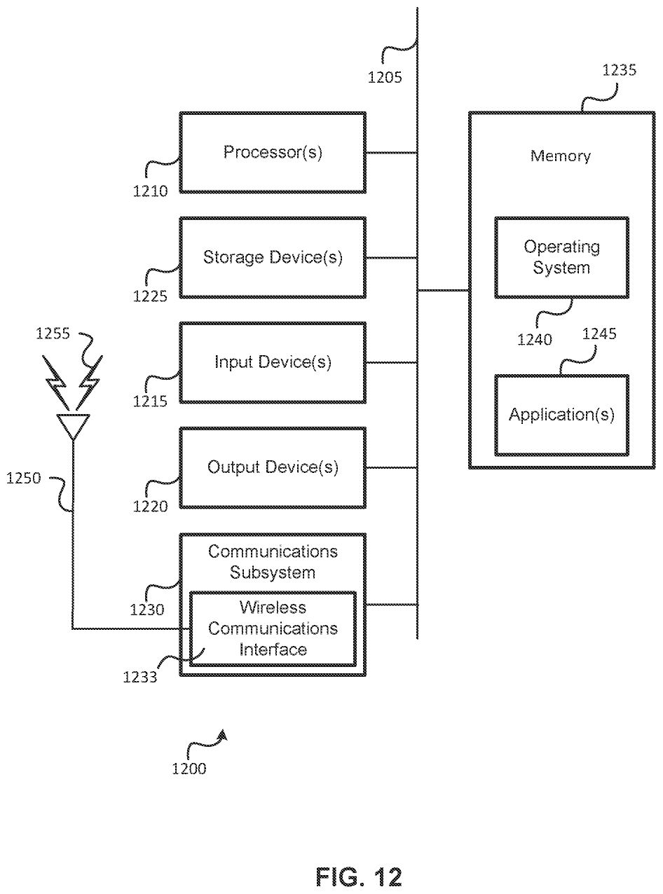

FIG. 12 is a block diagram of an embodiment of a computer system 1200, which may be used, in whole or in part, to support the functions of one or more network components as described in the embodiments herein (e.g., location server 160 of FIG. 1, external client 180 or 230 of FIG. 1 or 2, or LMF 220 of FIG. 2). It should be noted that FIG. 12 is meant only to provide a generalized illustration of various components, any or all of which may be utilized as appropriate. FIG. 12, therefore, broadly illustrates how individual system elements may be implemented in a relatively separated or relatively more integrated manner. In addition, it can be noted that components illustrated by FIG. 12 can be localized to a single device and/or distributed among various networked devices, which may be disposed at different geographical locations.

The computer system 1200 is shown comprising hardware elements that can be electrically coupled via a bus 1205 (or may otherwise be in communication, as appropriate). The hardware elements may include processor(s) 1210, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1200 also may comprise one or more input devices 1215, which may comprise without limitation a mouse, a keyboard, a camera, a microphone, and/or the like; and one or more output devices 1220, which may comprise without limitation a display device, a printer, and/or the like.

The computer system 1200 may further include (and/or be in communication with) one or more non-transitory storage devices 1225, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1200 may also include a communications subsystem 1230, which may comprise wireless communication technologies managed and controlled by a wireless communication interface 1233, as well as wired technologies (such as Ethernet, coaxial communications, universal serial bus (USB), and the like). The wireless communication interface 1233 may comprise one or more wireless transceivers may send and receive wireless signals 1255 (e.g., signals according to 5G NR or LTE) via wireless antenna(s) 1250. Thus the communications subsystem 1230 may comprise a modem, a network card (wireless or wired), an infrared communication device, a wireless communication device, and/or a chipset, and/or the like, which may enable the computer system 1200 to communicate on any or all of the communication networks described herein to any device on the respective network, including a User Equipment (UE), base stations and/or other TRPs, and/or any other electronic devices described herein. Hence, the communications subsystem 1230 may be used to receive and send data as described in the embodiments herein.

In many embodiments, the computer system 1200 will further comprise a working memory 1235, which may comprise a RAM or ROM device, as described above. Software elements, shown as being located within the working memory 1235, may comprise an operating system 1240, device drivers, executable libraries, and/or other code, such as one or more applications 1245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1225 described above. In some cases, the storage medium might be incorporated within a computer system, such as computer system 1200. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1200 and/or might take the form of source and/or installable code, which, upon compilation and/or installation on the computer system 1200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method for supporting positioning of a user equipment (UE) in a wireless network, the method comprising: defining one or more groups of antennas associated with a wireless network node, each of the one or more groups of antennas grouped according to at least a phase-based parameter correlated with an electromagnetic characteristic of a plurality of antennas; sending, to a network entity of the wireless network, data identifying the defined one or more groups of antennas; receiving configuration data from the network entity, the configuration data identifying at least one group of antennas of the one or more groups of antennas; and based on the configuration data, sending or receiving reference signals with the wireless network node using the identified at least one group of antennas of the one or more groups of antennas, the reference signals configured to be used in the positioning of the UE.

Clause 2: The method of clause 1, further comprising sending, to the network entity, information relating to a capability of the wireless network node, the capability indicative of whether the wireless network node is configured to support usage of multiple groups of the plurality of antennas grouped according to at least the phase-based parameter.

Clause 3: The method of any of clauses 1-2 wherein the wireless network node comprises a base station, the UE, or a peer UE different from the UE.

Clause 4: The method of any of clauses 1-3 wherein each of the one or more groups of antennas is located within the wireless network node such that a distance between two antennas within a group of antennas is defined; and the positioning of the UE is based at least on (i) the distance, and (ii) phases associated with the reference signals.

Clause 5: The method of any of clauses 1-4 further comprising determining an angle of departure (AoD) or an angle of arrival (AoA) based on a difference between the phases associated with the reference signals; wherein the positioning of the UE is further based on the AoD or the AoA.

Clause 6: The method of any of clauses 1-5 wherein the sending or receiving of the reference signals is further based on a request from the network entity.

Clause 7: The method of any of clauses 1-6 wherein the reference signals comprise an uplink reference signal or a downlink reference signal, the uplink reference signal comprising a sounding reference signal (SRS), the downlink reference signal comprising a positioning reference signal (PRS).

Clause 8: The method of any of clauses 1-7 wherein the network entity comprises a base station or a location management function (LMF).

Clause 9: The method of any of clauses 1-8 wherein the electromagnetic characteristic comprises: a phase noise, a relative phase, a phase bias, or a phase error margin, or a combination thereof.

Clause 10: The method of any of clauses 1-9 wherein the one or more groups of antennas comprise one or more phase-noise groups (PNGs), each of the PNGs characterized by a radio frequency (RF) signal source commonly implemented by a respective one of the one or more groups of antennas.

Clause 11: The method of any of clauses 1-10 wherein the data identifying the defined one or more groups of antennas comprises an identifier for each PNG of the defined one or more groups of antennas.

Clause 12: The method of any of clauses 1-11 wherein the positioning of the UE comprises either (i) performing an angle of departure (AoD) measurement based at least on the reference signals sent with the wireless network node using the identified at least one group of antennas, or (ii) performing an angle of arrival (AoA) measurement based at least on the reference signals received with the wireless network node using the identified at least one group of antennas.

Clause 13: The method of any of clauses 1-12 wherein the identified at least one group of antennas has been selected based on a reliability factor, the reliability factor determined by a machine learning algorithm applied to the data identifying the defined one or more groups of antennas.

Clause 14: The method of any of clauses 1-13 wherein each of the one or more groups of antennas comprises a subset of the plurality of antennas.

Clause 15: A wireless network node comprising: at least one wireless communication interface; memory; a plurality of antennas; and one or more processors communicatively coupled to the at least one wireless communication interface and the memory, and configured to: define one or more groups of antennas associated with the wireless network node, each of the one or more groups of antennas grouped according to at least a phase-based parameter correlated with an electromagnetic characteristic of the plurality of antennas; send, to a network entity of a wireless network, data identifying the defined one or more groups of antennas; receive configuration data from the network entity, the configuration data identifying at least one group of antennas of the one or more groups of antennas; and based on the configuration data, send or receive reference signals with the wireless network node using the identified at least one group of antennas of the one or more groups of antennas, the reference signals configured to be used in positioning of a user equipment (UE).

Clause 16: The wireless network node of clause 15, wherein the one or more processors are further configured to: send, to the network entity, information relating to a capability of the wireless network node, the capability indicative of whether the wireless network node is configured to support usage of multiple groups of the plurality of antennas grouped according to at least the phase-based parameter.

Clause 17: The wireless network node of any of clauses 15-16 wherein the wireless network node comprises a base station, the UE, or a peer UE different from the UE.

Clause 18: The wireless network node of any of clauses 15-17 wherein each of the one or more groups of antennas is located within the wireless network node such that a distance between two antennas within a group of antennas is defined; and the one or more processors are further configured to perform the positioning of the UE based on (i) the distance, (ii) phases associated with the reference signals, and (iii) an angle of departure (AoD) or an angle of arrival (AoA).

Clause 19: The wireless network node of any of clauses 15-18 wherein the reference signals comprise an uplink reference signal or a downlink reference signal, the uplink reference signal comprising a sounding reference signal (SRS), the downlink reference signal comprising a positioning reference signal (PRS).

Clause 20: The wireless network node of any of clauses 15-19 wherein the network entity comprises a base station or a location management function (LMF).

Clause 21: The wireless network node of any of clauses 15-20 wherein the electromagnetic characteristic comprises: a phase noise, a relative phase, a phase bias, or a phase error margin, or a combination thereof.

Clause 22: The wireless network node of any of clauses 15-21 wherein the one or more groups of antennas comprise corresponding one or more phase-noise groups (PNGs), each phase-noise group characterized by a radio frequency (RF) signal source commonly implemented by a respective one of the one or more groups of antennas.

Clause 23: The wireless network node of any of clauses 15-22 wherein the one or more processors are further configured to perform the positioning of the UE based on either (i) an angle of departure (AoD) measurement based at least on the reference signals sent with the wireless network node using the identified at least one group of antennas, or (ii) an angle of arrival (AoA) measurement based at least on the reference signals received with the wireless network node using the identified at least one group of antennas.

Clause 24: A computerized apparatus comprising: means for defining one or more groups of antennas associated with the computerized apparatus, each of the one or more groups of antennas grouped according to at least a phase-based parameter correlated with an electromagnetic characteristic of a plurality of antennas; means for sending, to a network entity of a wireless network, data identifying the defined one or more groups of antennas; means for receiving configuration data from the network entity, the configuration data identifying at least one group of antennas of the one or more groups of antennas; and means for, based on the configuration data, sending or receiving reference signals with the computerized apparatus using the identified at least one group of antennas of the one or more groups of antennas, the reference signals configured to be used in positioning of a user equipment (UE).

Clause 25: The computerized apparatus of clause 24, further comprising means for sending, to the network entity, information relating to a capability of the computerized apparatus, the capability indicative of whether the computerized apparatus is configured to support usage of multiple groups of the plurality of antennas grouped according to at least the phase-based parameter.

Clause 26: The computerized apparatus of any of clauses 24-25 wherein the one or more groups of antennas comprise corresponding one or more phase-noise groups (PNGs), each phase-noise group characterized by a radio frequency (RF) signal source commonly implemented by a respective one of the one or more groups of antennas.

Clause 27: The computerized apparatus of any of clauses 24-26 wherein the positioning of the UE comprises either (i) performing an angle of departure (AoD) measurement based at least on the reference signals sent with the computerized apparatus using the identified at least one group of antennas, or (ii) performing an angle of departure (AoA) measurement based at least on the reference signals received with the computerized apparatus using the identified at least one group of antennas.

Clause 28: A computer-readable apparatus comprising a storage medium, the storage medium comprising a plurality of instructions configured to, when executed by one or more processors: define one or more groups of antennas associated with a computerized apparatus, each of the one or more groups of antennas grouped according to at least a phase-based parameter correlated with an electromagnetic characteristic of a plurality of antennas; send, to a network entity of a wireless network, data identifying the defined one or more groups of antennas; receive configuration data from the network entity, the configuration data identifying at least one group of antennas of the one or more groups of antennas; and based on the configuration data, send or receive reference signals with the computerized apparatus using the identified at least one group of antennas of the one or more groups of antennas, the reference signals configured to be used in positioning of a user equipment (UE).

Clause 29: The computer-readable apparatus of clause 28, wherein the one or more groups of antennas comprise corresponding one or more phase-noise groups (PNGs), each phase-noise group characterized by a radio frequency (RF) signal source commonly implemented by a respective one of the one or more groups of antennas.

Clause 30: The computer-readable apparatus of any of clauses 28-29 wherein the positioning of the UE comprises either (i) an angle of departure (AoD) measurement based at least on the reference signals sent with the computerized apparatus using the identified at least one group of antennas, or (ii) an angle of departure (AoA) measurement based at least on the reference signals received with the computerized apparatus using the identified at least one group of antennas.

What is claimed is:

1. A method for supporting positioning of a user equipment (UE) in a wireless network, the method comprising:
defining one or more groups of antennas associated with a wireless network node, each of the one or more groups of antennas grouped according to at least a phase-based parameter correlated with an electromagnetic characteristic of a plurality of antennas;
sending, to a network entity of the wireless network, data identifying the defined one or more groups of antennas;
receiving configuration data from the network entity, the configuration data identifying at least one group of antennas of the one or more groups of antennas; and
based on the configuration data, sending or receiving reference signals with the wireless network node using the identified at least one group of antennas of the one or more groups of antennas, the reference signals configured to be used in the positioning of the UE.

2. The method of claim 1, further comprising sending, to the network entity, information relating to a capability of the wireless network node, the capability indicative of whether the wireless network node is configured to support usage of multiple groups of the plurality of antennas grouped according to at least the phase-based parameter.

3. The method of claim 1, wherein the wireless network node comprises a base station, the UE, or a peer UE different from the UE.

4. The method of claim 1, wherein:
each of the one or more groups of antennas is located within the wireless network node such that a distance between two antennas within a group of antennas is defined; and
the positioning of the UE is based at least on (i) the distance, and (ii) phases associated with the reference signals.

5. The method of claim 4, further comprising determining an angle of departure (AoD) or an angle of arrival (AoA) based on a difference between the phases associated with the reference signals;
wherein the positioning of the UE is further based on the AoD or the AoA.

6. The method of claim 1, wherein the sending or receiving of the reference signals is further based on a request from the network entity.

7. The method of claim 1, wherein the reference signals comprise an uplink reference signal or a downlink reference signal, the uplink reference signal comprising a sounding reference signal (SRS), the downlink reference signal comprising a positioning reference signal (PRS).

8. The method of claim 1, wherein the network entity comprises a base station or a location management function (LMF).

9. The method of claim 1, wherein the electromagnetic characteristic comprises: a phase noise, a relative phase, a phase bias, or a phase error margin, or a combination thereof.

10. The method of claim 9, wherein the one or more groups of antennas comprise one or more phase-noise groups (PNGs), each of the PNGs characterized by a radio frequency (RF) signal source commonly implemented by a respective one of the one or more groups of antennas.

11. The method of claim 10, wherein the data identifying the defined one or more groups of antennas comprises an identifier for each PNG of the defined one or more groups of antennas.

12. The method of claim 1, wherein the positioning of the UE comprises either (i) performing an angle of departure (AoD) measurement based at least on the reference signals sent with the wireless network node using the identified at least one group of antennas, or (ii) performing an angle of arrival (AoA) measurement based at least on the reference signals received with the wireless network node using the identified at least one group of antennas.

13. The method of claim 1, wherein the identified at least one group of antennas has been selected based on a reliability factor, the reliability factor determined by a machine learning algorithm applied to the data identifying the defined one or more groups of antennas.

14. The method of claim 1, wherein each of the one or more groups of antennas comprises a subset of the plurality of antennas.

15. A wireless network node comprising:
at least one wireless communication interface;
memory;
a plurality of antennas; and
one or more processors communicatively coupled to the at least one wireless communication interface and the memory, and configured to:
define one or more groups of antennas associated with the wireless network node, each of the one or more groups of antennas grouped according to at least a phase-based parameter correlated with an electromagnetic characteristic of the plurality of antennas;
send, to a network entity of a wireless network, data identifying the defined one or more groups of antennas;
receive configuration data from the network entity, the configuration data identifying at least one group of antennas of the one or more groups of antennas; and
based on the configuration data, send or receive reference signals with the wireless network node using the identified at least one group of antennas of the one or more groups of antennas, the reference signals configured to be used in positioning of a user equipment (UE).

16. The wireless network node of claim 15, wherein the one or more processors are further configured to:
send, to the network entity, information relating to a capability of the wireless network node, the capability indicative of whether the wireless network node is configured to support usage of multiple groups of the plurality of antennas grouped according to at least the phase-based parameter.

17. The wireless network node of claim 15, wherein the wireless network node comprises a base station, the UE, or a peer UE different from the UE.

18. The wireless network node of claim 15, wherein:
each of the one or more groups of antennas is located within the wireless network node such that a distance between two antennas within a group of antennas is defined; and
the one or more processors are further configured to perform the positioning of the UE based on (i) the distance, (ii) phases associated with the reference signals, and (iii) an angle of departure (AoD) or an angle of arrival (AoA).

19. The wireless network node of claim 15, wherein the reference signals comprise an uplink reference signal or a downlink reference signal, the uplink reference signal comprising a sounding reference signal (SRS), the downlink reference signal comprising a positioning reference signal (PRS).

20. The wireless network node of claim 15, wherein the network entity comprises a base station or a location management function (LMF).

21. The wireless network node of claim 15, wherein the electromagnetic characteristic comprises: a phase noise, a relative phase, a phase bias, or a phase error margin, or a combination thereof.

22. The wireless network node of claim 21, wherein the one or more groups of antennas comprise corresponding one or more phase-noise groups (PNGs), each phase-noise group characterized by a radio frequency (RF) signal source commonly implemented by a respective one of the one or more groups of antennas.

23. The wireless network node of claim 15, wherein the one or more processors are further configured to perform the positioning of the UE based on either (i) an angle of departure (AoD) measurement based at least on the reference signals sent with the wireless network node using the identified at least one group of antennas, or (ii) an angle of arrival (AoA) measurement based at least on the reference signals received with the wireless network node using the identified at least one group of antennas.

24. A computerized apparatus comprising:
means for defining one or more groups of antennas associated with the computerized apparatus, each of the one or more groups of antennas grouped according to at least a phase-based parameter correlated with an electromagnetic characteristic of a plurality of antennas;
means for sending, to a network entity of a wireless network, data identifying the defined one or more groups of antennas;
means for receiving configuration data from the network entity, the configuration data identifying at least one group of antennas of the one or more groups of antennas; and
means for, based on the configuration data, sending or receiving reference signals with the computerized apparatus using the identified at least one group of antennas of the one or more groups of antennas, the reference signals configured to be used in positioning of a user equipment (UE).

25. The computerized apparatus of claim 24, further comprising means for sending, to the network entity, information relating to a capability of the computerized apparatus, the capability indicative of whether the computerized apparatus is configured to support usage of multiple groups of the plurality of antennas grouped according to at least the phase-based parameter.

26. The computerized apparatus of claim 24, wherein the one or more groups of antennas comprise corresponding one or more phase-noise groups (PNGs), each phase-noise group characterized by a radio frequency (RF) signal source commonly implemented by a respective one of the one or more groups of antennas.

27. The computerized apparatus of claim 24, wherein the positioning of the UE comprises either (i) performing an angle of departure (AoD) measurement based at least on the reference signals sent with the computerized apparatus using the identified at least one group of antennas, or (ii) performing an angle of departure (AoA) measurement based at least on the reference signals received with the computerized apparatus using the identified at least one group of antennas.

28. A computer-readable apparatus comprising a storage medium, the storage medium comprising a plurality of instructions configured to, when executed by one or more processors:
define one or more groups of antennas associated with a computerized apparatus, each of the one or more groups of antennas grouped according to at least a phase-based parameter correlated with an electromagnetic characteristic of a plurality of antennas;
send, to a network entity of a wireless network, data identifying the defined one or more groups of antennas;
receive configuration data from the network entity, the configuration data identifying at least one group of antennas of the one or more groups of antennas; and
based on the configuration data, send or receive reference signals with the computerized apparatus using the identified at least one group of antennas of the one or more groups of antennas, the reference signals configured to be used in positioning of a user equipment (UE).

29. The computer-readable apparatus of claim 28, wherein the one or more groups of antennas comprise corresponding one or more phase-noise groups (PNGs), each phase-noise group characterized by a radio frequency (RF) signal source commonly implemented by a respective one of the one or more groups of antennas.

30. The computer-readable apparatus of claim 28, wherein the positioning of the UE comprises either (i) an angle of departure (AoD) measurement based at least on the reference signals sent with the computerized apparatus using the identified at least one group of antennas, or (ii) an angle of departure (AoA) measurement based at least on the reference signals received with the computerized apparatus using the identified at least one group of antennas.
